(19) United States
(12) Patent Application Publication
(10) Pub. No.: US 2005/0016344 A1
(43) Pub. Date: Jan. 27, 2005

(54) Unloading and stacking system with adjustable backstop

(76) Inventor: Stanislaw J. Kozera, Dearborn Heights, MI (US)

Correspondence Address: CANTOR COLBURN, LLP, 55 GRIFFIN ROAD SOUTH, BLOOMFIELD, CT, 06002, US

(21) Appl. No.: 10/872,328

(22) Filed: Jun. 18, 2004

Related U.S. Application Data
(60) Provisional application No. 60/480,717, filed on Jun. 23, 2003.

(51) Int. Cl. B26D 7/06

(52) U.S. Cl. 83/84; 83/162

(57) ABSTRACT

Several improvements to an unloading and stacking mechanism for an automatic precision blanking machine are presented. Such mechanisms conventionally have at least one laterally arranged backstop support bar, a pair of vertical side guides and one or more vertical elongated dividers to axially align cut-to-length pieces of sheet metal, and one or more backstop assemblies to transversely align the distal edges of the severed pieces of sheet metal. The improvements include: (1) a lightweight hand-removable adjustable-length backstop for helping align short severed pieces of sheet metal that extend over only part of the pallet underneath; (2) a movable adjustable top guide for receiving and supporting distal end portions of one or more relatively flat thin flexible sheets of metal initially advanced out of and to be severed by the precision blanking machine; (3) hand-removable lightweight side guide assemblies for restraining side edges of extra short pieces of severed sheet metal successively being advanced out of the precision blanking machine; and (4) an improved backstop assembly having extended vertical face surfaces on the piece-contacting face members to help ensure the initial few severed pieces of cut-to-length pieces of sheet metal to drop to a pallet to begin forming a stack do not end up sliding partially under the contact members.

### CROSS-REFERENCE TO RELATED APPLICATION

This application claims priority to provisional patent application Ser. No. 60/480,717 filed Jun. 23, 2003 by the same inventor with the same title, the entire specification of which is incorporated herein by reference.

### BACKGROUND OF THE INVENTION

1. Field of the Invention

The present invention relates in general to unloading and stacking mechanisms used on precision blanking machines to stack the severed sheets or pieces of sheet metal successively one on top of another in an automatic fashion, and relates in particular to improvements in such mechanisms, including removable adjustable backstops and removable adjustable sheet guidance mechanisms.

2. Discussion

Precision blanking machines accurately cut large continuous rolls of sheet steel automatically into smaller pieces of precise length and width. These kinds of industrial machines are extremely sturdy and are also made to be frequently adjusted. A given machine can be set up and used to successively produce, from a large roll of sheet metal, a few hundred pieces or a few thousand pieces of a first size and thickness, then set up and run to cut a few hundred or thousand pieces of a second size, and then set up and run to cut a desired number of pieces of a third size, and so on. Also, the rolls of sheet metal can be changed so that rolls of different thicknesses and/or different types of metal can be used, thus producing pieces of different thicknesses and from different types of metal. Typically, the flat cut-to-length sheet metal pieces may range in size from a few inches in length and a few inches in width to a few feet in length and either a few inches in width or up to a few feet in width.

The precision blanking machine technology is highly developed, and can process rolls of continuous metal sheet ranging in size from 16 inches wide to up to 72 inches wide or even larger. A wider roll typically is continuously slit by slitter knives as the roll advances into several smaller continuous strips, which are thereafter periodically cut to the desired length transversely (i.e., orthogonal to the longitudinal axis of the continuous strips). These transverse cuts or shearing operations are automatically carried out in a well-known manner using high-speed cutters or flying cut-off shearing dies. For example, the Red Bud multi-cut precision blanking system from Red Bud Industries in Red Bud, Ill. (see their website at www.redbudindustries.com) levels, slits, and cuts to length a continuous roll all in one automatic continuous repetitive operation. Such a machine produces precision blanks to exact sizes and rather tight dimensional tolerances, such plus or minus 0.005″ (0.127 mm) on both length and width. These Red Bud brand precision blanking machines also deliver speed and flexibility, and have advanced leveling capabilities, and can readily process fairly thick and hard metal sheets, including, 10 gauge stainless steel rolls.

As a simple example, a precision blanking machine can process a 48-inch wide roll of sheet metal that is several hundred feet or several thousand feet in length. It does this by simultaneously severing this wide sheet into several identical longitudinal strips of uniform width, such as, for example, four continuous strips that are twelve inches wide, six continuous strips that are eight inches wide, or eight continuous strips that are six inches wide. Alternatively, if desired the same four-foot wide roll of sheet metal may be continuously severed into strips of different width, such as two continuous strips which are twelve inches wide, two continuous strips which are six inches wide, and three continuous strips which are four inches wide. The width of each strip can be accurately controlled. Similarly, the length of the pieces can be accurately controlled by controlling the speed of the advancing metal sheet and the time interval between successive cuts.

The unloading and stacking mechanisms found at the output end of these precision blanking machines are in principle supposed to receive the severed sheet metal pieces being ejected and very neatly stack them automatically on a pallet or other bed, so that one or more stacks located on the pallet or bed can be removed in their stacked state for use elsewhere. These stacks of cut-to-length sheets are typically stored temporarily in a storage area or warehouse for later use or sale, or are sent directly to a remote factory where they are used.

Typically, the stacks of identical-sized clean sheet metal pieces are banded together with metal straps for shipment. Frequently, the metal bands also are looped around and through the pallet underneath to secure the stacks to the pallet for shipment. The banded stacks sometimes are also covered with a polyethylene film wrap or similar plastic wrapping material to help reduce the chances of environmental contamination during shipment and/or storage.

In a typical blanking machine operation, several hundred to several thousand cut-to-length pieces are cut at one time by the blanking machine with fully severed pieces being successively stacked on a pallet in one or more vertical stacks. These vertical stacks of cut-to-length pieces are preferably very neatly arranged on top of the pallet for at least a few reasons. First, very neat stacks facilitate placing plastic or metal straps or bands around the stacks and pallet thereunder so as to secure the stacks for shipment to a remote location. Second, they facilitate the automatic handling of the cut-to-length pieces by other industrial equipment which will be used to further process the blank cut-to-length sheets into a finished part, ready to be used in some appliance, vehicle, assembly or machine. Third, they reduce the likelihood that the protruding edges (which are inevitable if the pieces are offset slightly from one another, as in an uneven stack) will be damaged by the tightly-bound straps or any other object which may accidentally bump into such exposed edges. Fourth, arranging all of the pieces in one stack so that none is offset in any direction reduces the possibility of subsequent corrosion or contamination of such a protruding sheet as will now be explained.

The cut-to-length pieces are typically very flat and provide essentially no space between the stacked sheets. When the stack of sheets is perfectly aligned, the only portions of the sheets exposed to the atmosphere or even environmental contaminants are the edges and the top surface of the top sheet and bottom surface of the bottom sheet. But, when the stacking of the sheets is uneven, it will expose small strips of the upper and lower surfaces of such offset sheets to the environmental contaminants, particularly if the stacks are not covered completely in a polyethylene film or other plastic film prior to shipment. During shipment by flatbed trailers or rail cars or other forms of conveyance, uncovered stacked sheets may well be exposed to environmental contaminants or high levels of moisture. The contaminants may include road grime, airborne dirt and sand, road-salt or road dust. The moisture may be due to rain, mist or high humidity. Such contaminants or moisture may corrode or oxidize the exposed surface, thus requiring the scrapping of or the expensive cleaning of any sheet having a contaminated portion, even when the exposed area constitutes a small percentage of the overall surface area of the sheet. Accordingly, it is very useful to ensure that the same-size sheets are stacked with a high degree of uniformity, exactly one on top of the other, both lengthwise and widthwise, so as to present only the edge of the sheets to such environmental contamination.

To summarize, precision blanking machines have now achieved a high degree of automation, and can largely run by themselves, once properly set up and loaded with the large roll of sheet metal to be processed. Thus, like many industrial processes, the most labor-intensive aspects of the operation of these machines now have to do with: (a) the set-up of the machines to run different parts; (b) the loading of the raw materials (i.e., the coils of sheet metal) into the machines from time to time; and (c) the unloading of the finished materials (i.e., the pallets containing stacks of cut-to-size pieces) at the unload stations of the machines (i.e., the unloader/stackers of the blanking machines). With modern blanking machines, problems with the unloading and stacking mechanisms often are among the most troublesome and labor intensive areas of their operation. Consistently stacking metal sheets of all different sizes and thicknesses has turned out to be much more difficult than those outside of this particular field might guess. In particular, cut-to-size flat sheets of metal with the following characteristics have all proven to present unloading and/or stacking challenges for different reasons: (a) pieces that are extra long and thin; (b) pieces that are extra short; (c) pieces that are extra narrow; and (d) pieces that are extra short and narrow.

The present invention is directed to improvements in the unloading and stacking operations of such precision blanking machines, particularly with regard to the four kinds of troublesome size sheets just identified above. A first main objective of the present invention is to provide some sort tool or structure for the unloading and stacking mechanism to make it much easier to handle one or more initially presented, longitudinally severed, identical-length pieces of sheet metal that are so long and thin that they droop on account of gravity. Normally, the distal edges of such drooping pieces of sheet metal contacts the pallet, and will catch on and/or become bound up or stuck in any openings or cracks within the pallet. This problem occurs only with the initial or first-cut pieces that are placed on the pallet as they are being ejected out of the machine. Often, two or more workers must stand around the unloader/stacker of the blanking machine and use long poles to hold up the drooping metal, as the metal web in the blanking machine is inched forward. This is a very awkward situation. It can require many workers when there are multiple strips of metal to be supported. This happens for example when the blanking machine is set up to produce six or eight strips of metal simultaneously.

A second main objective of the present invention is to provide some sort of tool or structure for ensuring the reliable and very uniform stacking of shorter-length pieces of cut metal, particularly those pieces located on the outer sides of the stacks of cut metal pieces. Presently, extra short pieces cannot be reliably stacked.

A third main objective of the present invention is to provide a tool or structure for helping locate the distal edge of the cut pieces that are short and thus do not extend over the full length of the pallet underneath, as such pieces are ejected from the blanking machine into the unloading and stacking mechanism. In other words, the purpose of this tool or structure is to help ensure reliable and very uniform stacking of these shorter piece lengths of cut metal on the pallet.

A fourth main objective of the present invention is to provide an improved backstop structure that helps ensure the first few initial cut pieces of sheet metal dropped into a stack on a pallet register correctly, rather than sliding under a portion of the backstop as is now experienced with conventional backstops with which I am familiar.

A fifth main objective of the present invention is to meet the first through fourth main objectives with tools or structures that are preferably simple and sturdy in construction, relatively light in weight so that they can be maneuvered and installed and removed by hand. A related objective is to make the devices of the present invention adjustable where that is beneficial, such that they can be readily positioned as needed to help neatly stack sheets of cut metal of different sizes.

### SUMMARY OF THE INVENTION

In light of the foregoing problems and in order to fulfill the first of the foregoing objectives, there is provided, in accordance with a first aspect of the present invention, a movable top guide, for use in the unloader/stacker portion of a precision blanking machine, that receives and supports the distal end of one or more cut pieces of identical-length metal sheet that are extra long and thin, as these end portions of the pieces are first being advanced out of the precision blanking machine into the unloader/stacker area, prior to being severed. When two more pieces of identical length are to be cut simultaneously, the unloading and stacking mechanism of an automatic precision blanking machine is normally set up with at least first and second elongated vertically arranged dividers spaced apart from and arranged parallel to one another. The top guide preferably slides along the top edges of those dividers. The top guide preferably comprises an elongated substantially rigid support structure longitudinally movable with respect to the first and second dividers and of sufficient length to span transversely across and be slidably supported by the upper edge portions of the first and second dividers. The support structure includes at least a first front elongated wall portion, a first central wall elongated portion, and a first rear elongated wall portion. The front wall portion is arranged to support at least one underside surface of a first thin flexible elongated strip of sheet metal near the distal end thereof as the strip of sheet metal is being advanced out of and being severed by the precision blanking machine into a cut-to-length piece.

The rear wall portion is preferably arranged to be contacted by the distal edge of the thin flexible elongated strips of sheet metal being advanced out of the blanking machine. In this manner the support structure is advanced along the dividers by the advancing distal edge of the strip of sheet metal. Accordingly, the distal end of the first strip of sheet metal as it is advanced out of the precision blanking machine is thus supported for a substantial distance along the dividers until the first strips are finally severed into a cut-to-length piece and drop on account of gravity between the dividers. In one embodiment of the movable top guide, the substantially rigid support structure includes at least first and second elongated formed members adjustable with respect to one another and partially nestable within one another in order to extend across and be slidably supported by the upper edge portions of the first and second elongated dividers when those first and second dividers are set at different spacings to accommodate cut-to-length pieces of sheet metal having different widths that are to be stacked.

There is provided, in accordance with second aspect of the present invention, a plurality of hand-removable lightweight side guide assemblies for restraining side edges of extra short pieces of severed sheet metal successively being advanced out of the precision blanking machine. The side guide assemblies are preferably identical so that the same style can be used on either side of the machine. These lightweight easily removed assemblies preferably are removably mounting to an existing or known side guide structure or plate which is normally provided as part of the blanking machine. Each such lightweight side guide assembly of the present invention comprises: a first elongated formed member having a substantially flat large surface portion and a first substantially flat small surface portion arranged at an obtuse angle with respect to the large surface portion; and a second elongated formed member having a substantially flat large surface portion and a first small surface portion generally arranged at an obtuse angle with respect to the large surface portion, and also having a second small surface portion arranged at an acute angle relative to the first small surface portion so as to form a hanger structure, whereby the second elongated formed member is arranged to be hung from one of the side guide plates or vertically arranged dividers of the unloading and stacking mechanism. Further, the first and second elongated members are arranged so that the large surface of the first elongated formed member is positionable to be contacted by the side edges of the flat thin sheets of sheet metal to be restrained as gravity causes them to drop. In this manner, the thin sheets of sheet metal drop into a stack of severed pieces of sheet metal where the restrained edges of pieces of sheet metal are neatly arranged in a common generally vertical plane.

Preferably, the first and second elongated members of the side guide assembly are rigidly connected together such that the large substantially flat surfaces of the first and second formed members are maintained in substantially parallel relation and are spaced apart from one another. The assembly may also further comprise a third elongated formed member rigidly connected to and spacing the first and second elongated members from one another in the substantially parallel relation, the third formed member being connected to the substantially flat large surfaces of the first and second members. Also, the second and third members are preferably shorter in length than the first member and are centrally located with respect to the large flat surface of the first member.

There is provided, in accordance with a third aspect of the present invention, a lightweight hand-removable backstop for use in an unloader/stacker to help align short severed pieces of sheet metal that extend over only part of the pallet underneath. This hand-removable backstop may be made in different lengths to handle different lengths of cut metal pieces. Alternatively, it may be constructed out of telescoping interconnected members such as rectangular tubes so that it is adjustable, and can be easily sized as needed to handle a particular length of pieces of sheet metal. These removable backstop structures of the present invention easily set up to extend over part of the pallet, and thus help ensure the formation of a very neat stack of severed pieces of metal successively being advanced out of and transversely cut by the blanking machine.

Each hand-removable backstop structure of the present invention preferably comprises an elongated substantially rigid structure arranged to be removably installed upon and rigidly supported in a position by the backstop support of the unloading and stacking mechanism, and to extend out, preferably substantially horizontally, over a portion of the pallet upon which the severed pieces of cut metal will be stacked. This rigid structure preferably has first, second and third elongated sections, with the first and third sections being generally vertically arranged when the backstop is in use, and the second section being generally horizontally arranged when the backstop is in use. The first section is configured to be hand-mounted upon and mechanically supported by a backstop support. The second section is disposed between and operatively rigidly interconnecting the first and third sections. The third section has at least one substantially flat large surface portion arranged to have a generally vertical orientation when the backstop is in use.

The backstop of the present invention is of sufficient length in a horizontal direction such that, when it is in use, all of the third section and at least a significant portion of the second section extend over at least part of a pallet positioned therebelow upon which ejected pieces of cut-to-length sheet metal are stacked as they are severed by the blanking machine and dropped into the unloading and stacking mechanism. Also, the large flat surface portion of the third section is configured to be generally perpendicular to the direction of the advancing strips of sheet metal prior to being severed. The backstop is arranged so that its third section will be positioned when in use to restrain the distal edges of the severed cut-to-length pieces of sheet metal as gravity causes them to drop. With the foregoing arrangement, the severed pieces of sheet of sheet metal will thus drop into a very neat stack upon the pallet with their restrained distal edges neatly arranged in a common generally vertical plane.

There is provided, in accordance with a fourth aspect of the present invention, an improved backstop assembly for use in an unloading and stacking mechanism of an automatic precision blanking machine. This improved assembly resembles a conventional backstop assembly, except that has extended vertical face surfaces on contact members to help ensure the initial few severed pieces of cut-to-length pieces of sheet metal to drop to a pallet to begin forming a stack do not end up sliding partially under the contact members. Also, the improved backstop assembly may be each include an upper portions on the faces of the generally vertically arranged projecting contact members that have a slanted surface which extends upwardly and away from the vertically flat part of the face portion therebelow. This slanted surface is preferably sufficiently steeply sloped to assist in ensuring that distal edges of severed cut-to-length pieces of sheet metal fall downwardly toward an area to help create or form a neat stack of cut-to-length pieces.

These and other aspects, objectives and advantages of the present invention may be further understood by referring to the detailed description, accompanying Figures, and appended claims.

### BRIEF DESCRIPTION OF THE DRAWINGS

The drawings form an integral part of the description of the preferred embodiments and are to be read in conjunction therewith. Like reference numerals designate the same or similar components or features in the various Figures, where:

FIG. 1 is a simplified perspective view showing a first aspect of the present invention, namely two improved backstop assemblies (further illustrated in FIGS. 17 and 18) mounted on a backstop support bar, in use in the prior art environment of an otherwise conventional unloading and stacking mechanism used with a known precision blanking machine that cuts sheet metal to accurate lengths and then places the severed pieces in a neat stack, one on top of the other, upon a pallet placed upon a stacker platform;

FIG. 2 is a simplified side elevational view in partial cross-section showing a known prior art machine in simplified cross-section and a second aspect of the present invention, namely a first-cut slidable top guide for assisting the first severed pieces of drooping sheet metal ride all the way to the backstop before being dropped to the pallet on the stacker platform below;

FIG. 3 is a simplified top view of a conventional prior art unloading and stacking mechanism used with a known precision blanking machine to help illustrate how the machine cuts a continuous wide roll of sheet metal into a plurality of strips (five strips are shown), which are then severed into pieces and which are supposed to fall into in a generally neat stack, one on top of the other, upon a rectangular pallet placed upon a stacker platform below, with the assistance of four vertical dividers and four backstops;

FIG. 4 is a simplified plan view of the unloading and stacking mechanism similar to that shown in FIG. 3, where the first-cut slidable top guide of the present invention is shown supporting the three central elongated strips of the thin flexible sheet metal;

FIG. 5 is a perspective front view of a first possible construction of the first-cut top guide of the present invention shown in FIGS. 2 and 4, and it is made from one piece of sheet metal;

FIG. 6 is side elevational view of the FIG. 5 slidable top guide taken from the right side of FIG. 5, showing the top guide shown positioned on top of vertical dividers, and being pushed forward by an advancing strip of drooping sheet metal shown in phantom;

FIG. 7 shows a second preferred construction of the slidable top guide of the present invention, which is made from two pieces of sheet metal nested within one another, and whose size is adjustable, as indicated by the phantom lines;

FIG. 8 is side elevational view of the FIG. 7 top guide, taken from the right side of FIG. 7, showing the top guide positioned on top of vertical dividers;

FIG. 9 is a front elevational view of a longer version of the slidable top guide of the present invention spanning across five intermediate dividers which is arranged to support four strips of sheet metal that are to drop in between the dividers;

FIG. 10 is a simplified side elevational view in partial cross-section of an unloading and stacking mechanism set up to handle extra short pieces of severed sheet metal successively being advanced out of the precision blanking machine, which also illustrates third and fourth aspects of the present invention, namely a hand-removable lightweight side guide assembly for restraining side edges of extra-short pieces of severed sheet metal (also shown in FIGS. 11 and 12), and an adjustable length removable backstop assembly (also shown in FIG. 13) mounted on the improved regular backstops of the present invention (also shown in FIG. 18);

FIGS. 11 and 12 are perspective and end views respectively of the hand-removable lightweight side guide assembly of the present invention (also shown in FIG. 10);

FIG. 13 is perspective view of an adjustable length removable backstop assembly of the present invention (also shown in FIG. 10), which more clearly shows the mounting portion which has a H-shaped cross-section;

FIGS. 14 and 15 are perspective views of two fixed length lightweight removable backstop assemblies of the present invention that can be used in the same manner are the FIG. 13 backstop assembly, with the FIG. 14 device being substantially longer than the FIG. 15 device;

FIG. 16 is a perspective view of a prior art removable backstop used with the unloading and stacking mechanism of a conventional precision blanking machine;

FIG. 17 is a fragmentary side elevational view of a prior art removable backstop used as part of the unloading and stacking mechanism of a conventional precision blanking machine, illustrating the problem of the initial few pieces of sheet metal sliding under part of the backstop and therefore being offset from the rest of the sheets above them;

FIG. 18 is a perspective view of the improved removable backstop of the present invention, showing its filled-out base area and its sloped upper area;

FIG. 19 is a fragmentary side elevational view of the FIG. 18 backstop, which avoids the problem of the initial few pieces of sheet metal sliding under part of the backstop; and

FIG. 20 is a fragmentary side elevational view of a modified version of the FIG. 18 backstop.

### DETAILED DESCRIPTION OF THE PREFERRED EMBODIMENTS

The various aspects of the present invention are illustrated and described herein in connection with certain embodiments, with the understanding that the present disclosure is to be considered as an exemplification of the principles of the invention and the associated mechanical and functional specifications required for its implementation. However, it should be appreciated that the devices, assemblies, and methods of the present invention may be implemented in still different configurations, forms, steps and other variations, based on the teachings herein.

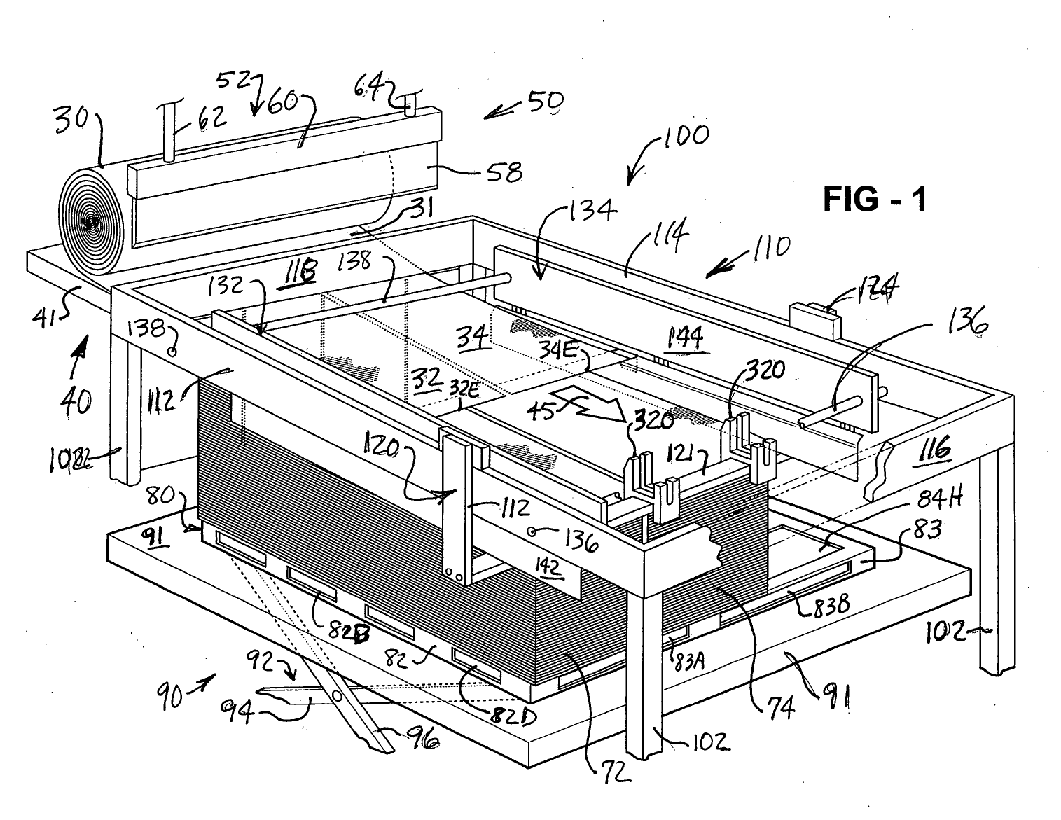

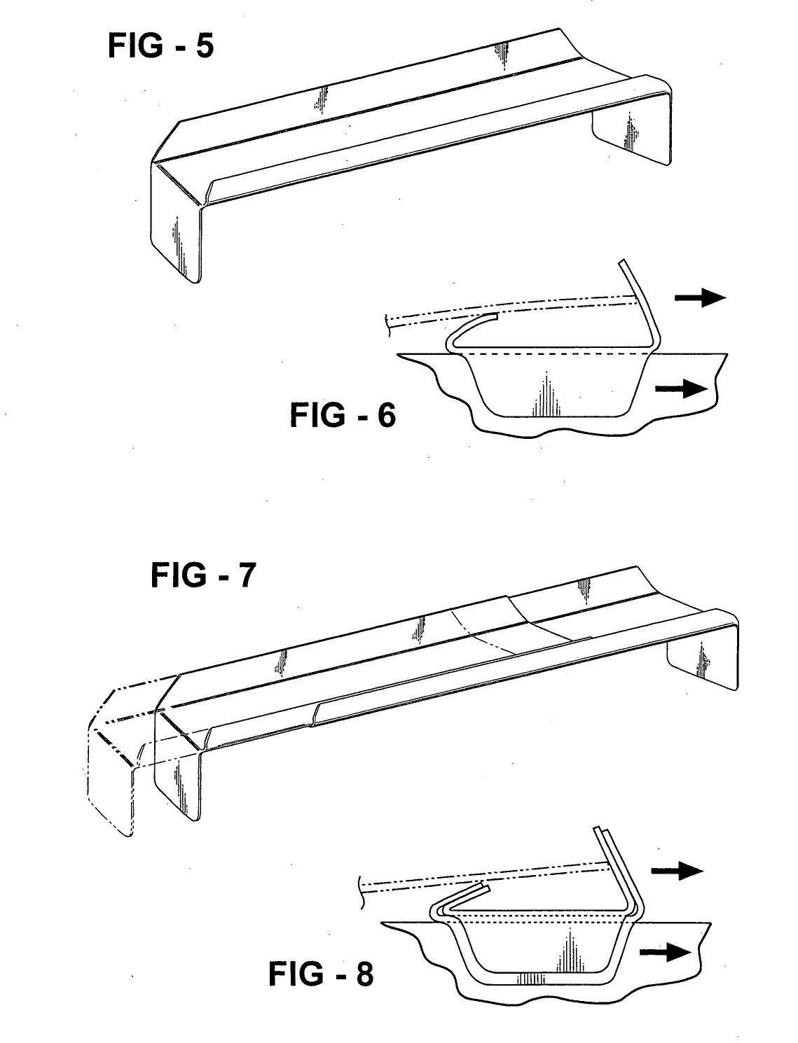

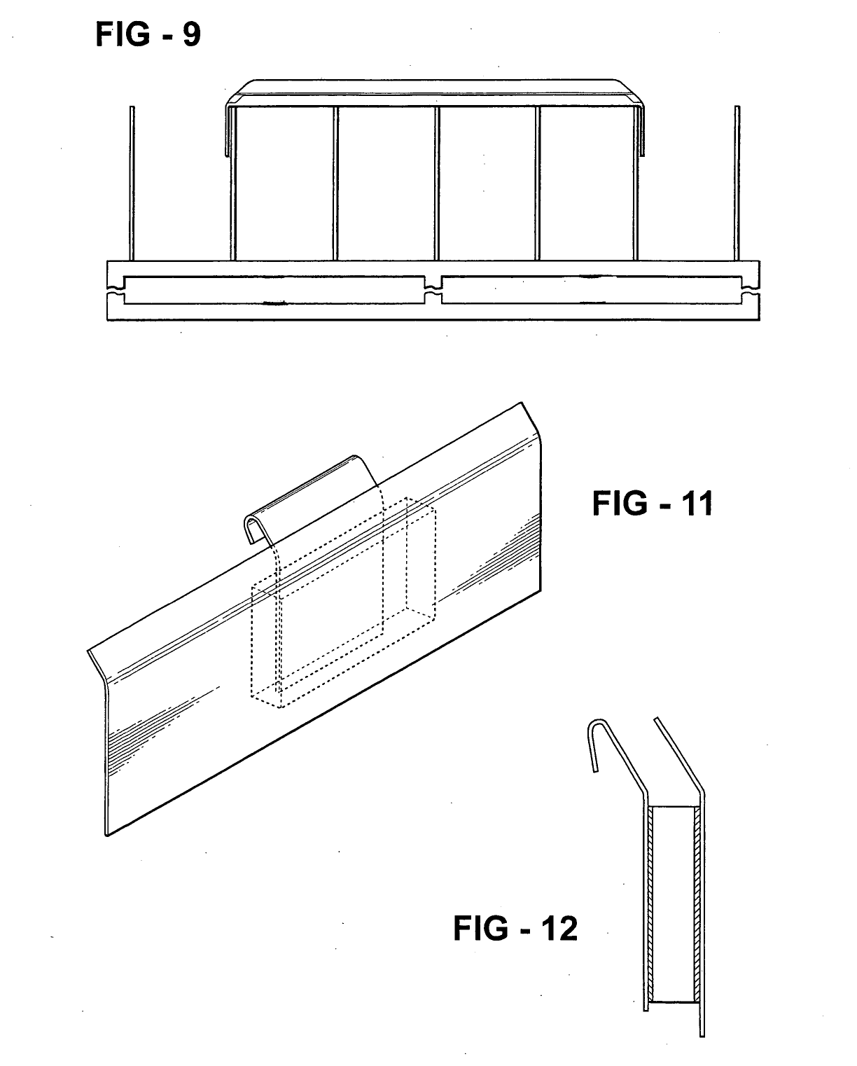

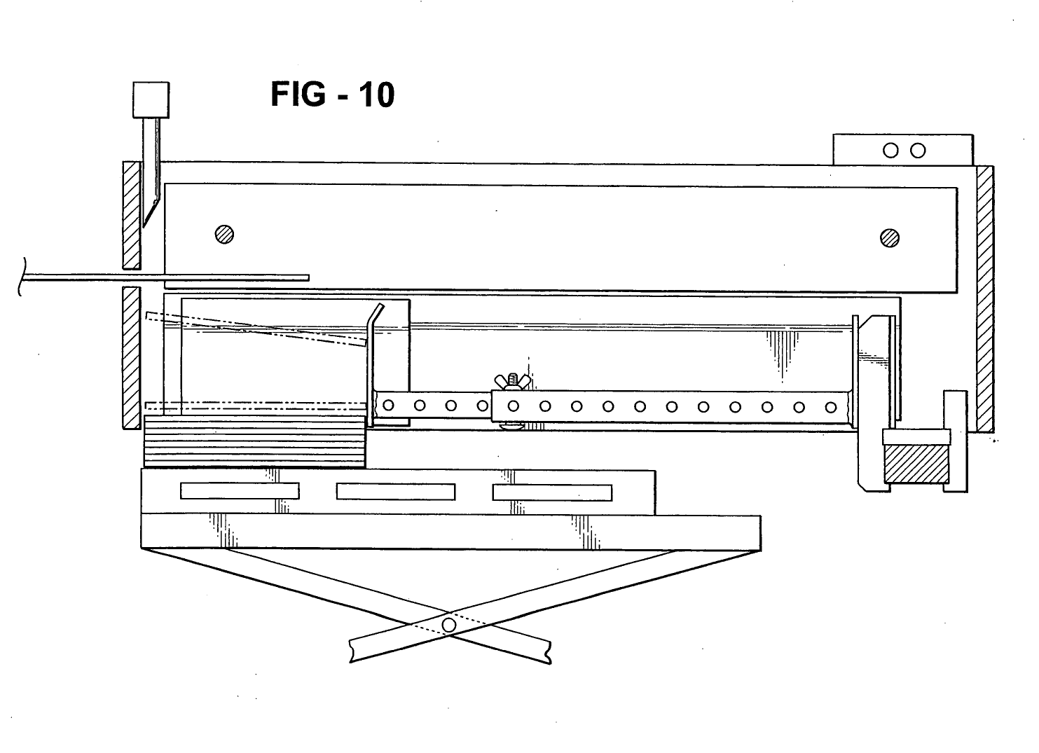

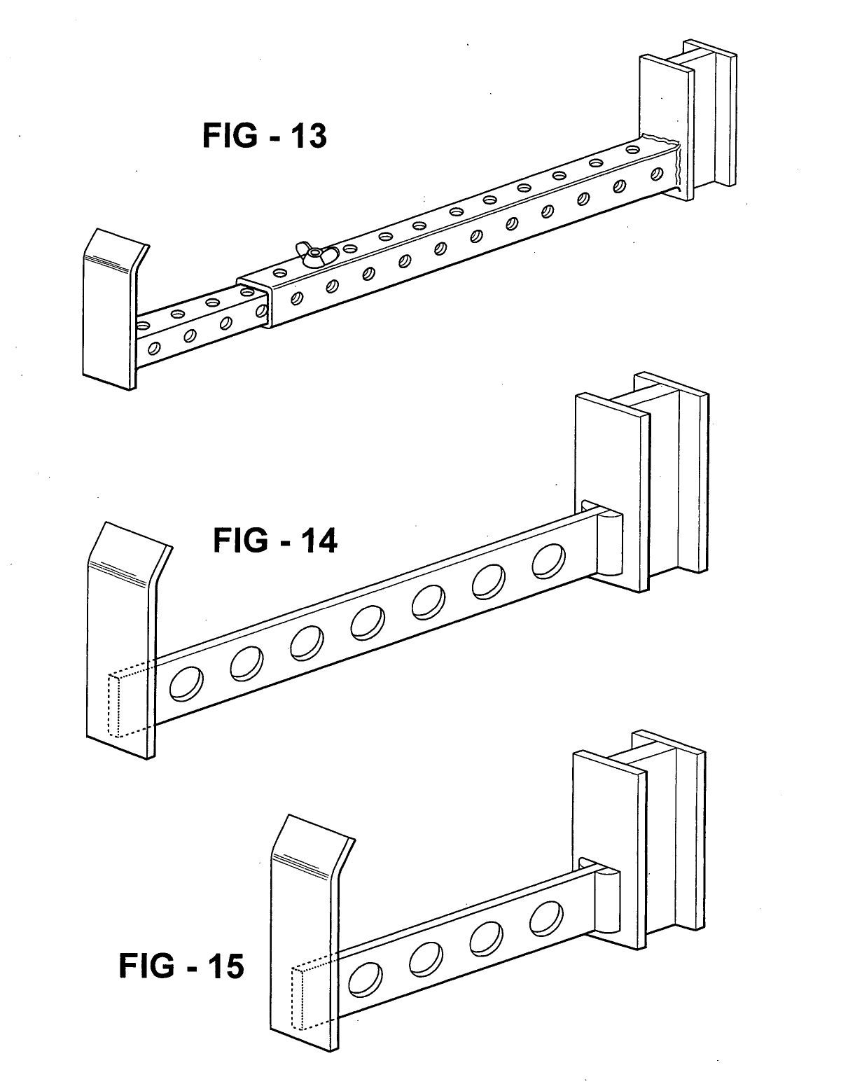

FIGS. 1, 2, 3, 9, 16 and 17 together illustrate various known aspects of a conventional precision blanking machine, its unloading and stacking mechanism, and conventional hand-movable backstops used therewith. As previously mentioned, blanking machines cut sheet metal pieces to accurate lengths and widths automatically, and also place those fully severed pieces in one or more generally neat stacks, one piece on top of the other, upon a pallet. The pallet in turn is placed upon a movable stacker platform located underneath the unloader/stacker mechanism. The stacker platform can be lowered substantially so that the pallet can moved transversely away from the rest of the unloading mechanism to allow forklift trucks to access a loaded pallet more easily. In order to make the purpose and use of the devices and assemblies of the present invention which are designed to be used in this environment easier to understand, it is useful to briefly discuss certain conventional components of this type of machinery which are shown in these Figures.

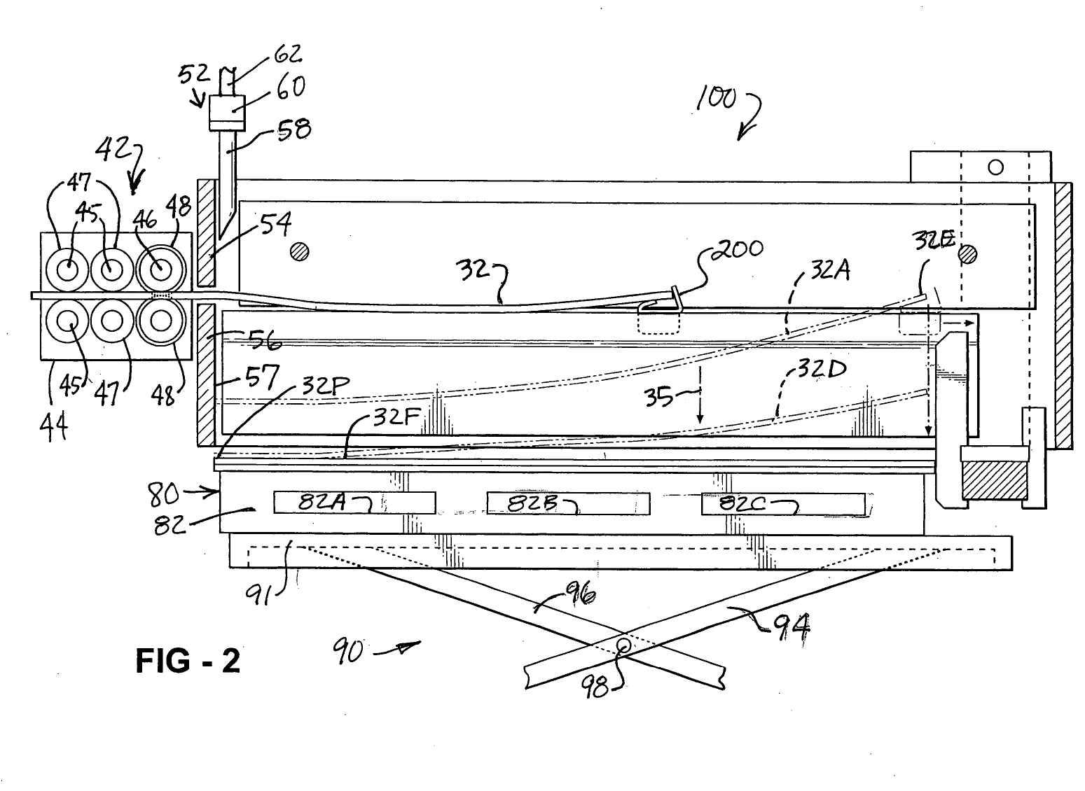

FIGS. 1, 2 and 3 show perspective, right side and top views of a typical conventional precision blanking machine and its unloader/stacker. Also, as noted earlier, FIGS. 1 and 2 also help illustrate certain aspects of the devices of the present invention. FIG. 1 shows a large roll 30 of coiled steel sheet or other metal sheet which is supported in a known way by a precision blanking machine 40 so that it may be uncoiled, flattened, severed into long continuous strips of desired width, which are then cut up into pieces of desired width. In FIG. 1, most of the blanking machine 40 is not shown, except for part of its lower support framework 41, a roller drive and cutter mechanism 42 for advancing the web of unrolled metal sheet and severing it into longitudinal strips, and cut-off mechanism 50 which includes a vertically reciprocable shearing assembly 52 with upper shearing guide plate 54 and lower die and guide plate 56 (shown in FIG. 2) having a vertical wall or face 57. Shearing assembly 52 includes an elongated transversely-oriented shearing blade 58 that is supported by a suitable blade-holding clamping means 60 attached to vertically-arranged conventional reciprocable drive shafts 62 and 64. All of these conventional items just named form no part of the devices of the present invention, but are included in the figures herein and will briefly described so that the various aspects of and purposes and use of the present invention may be better understood.

The roll 30 of metal is unrolled into the unloader/stacking mechanism, which is generally indicated by reference numeral 100. As shown in FIG. 1, the unrolled portion or web 31 of metal sheet is longitudinally severed into two elongated strips 32 and 34 which are moved in a forward direction by web drive mechanism 42 as shown by broad arrow 45. Then, as best shown in FIG. 2, the advancing strips are then the severed transversely by reciprocating shearing blade 58 to produce simultaneously produce two fully severed pieces of sheet metal, which fall by action of gravity onto the pallet below.

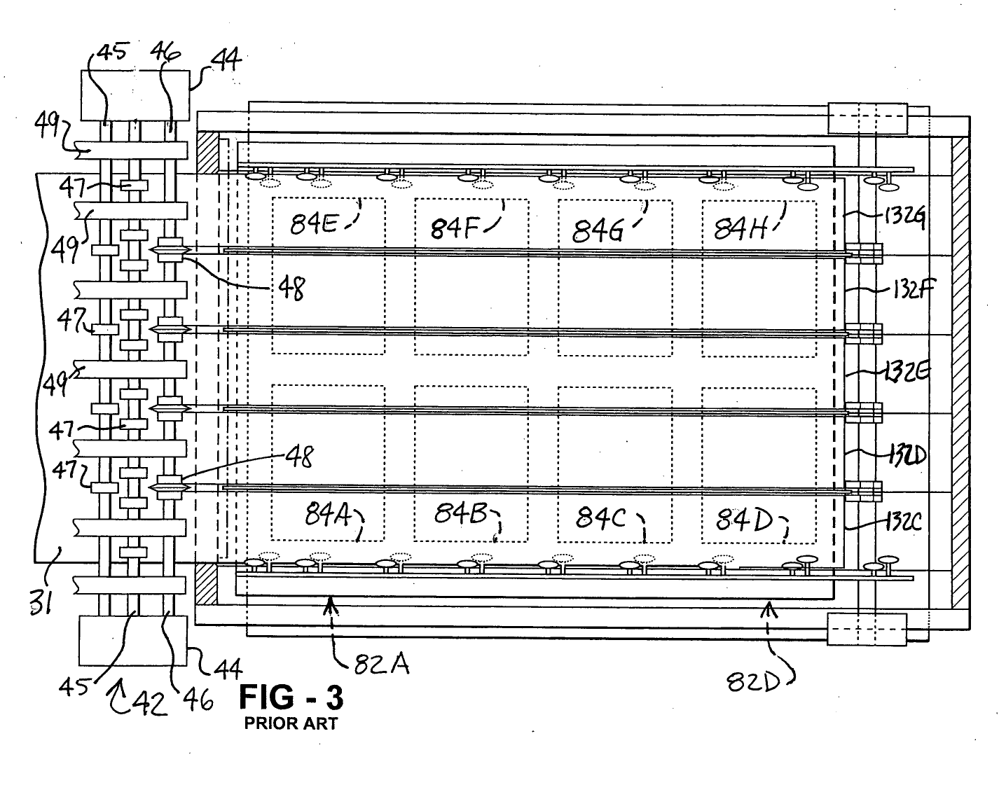

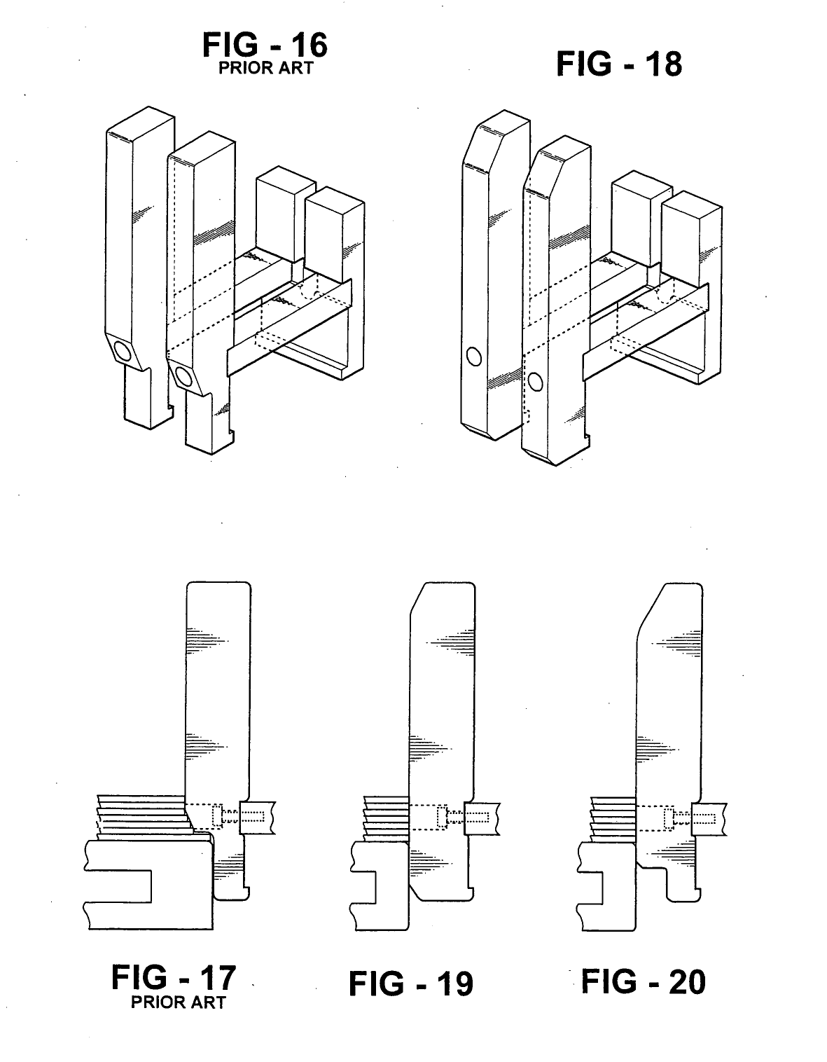

In FIG. 1, the forward movement of the strips 32 and 34 is constrained by the two identical improved backstops 250 of the present invention which will be described later in connection with FIGS. 18 through 20. (They could also have been constrained by the prior art backstops of the type shown in FIGS. 17 and 18.) The steel strips 32 and 34, when sufficiently far advanced so that their leading or distal edges 32E and 34E reach the backstops 320, are severed by the downward motion of reciprocating of shearing blade 58, as best shown in FIG. 2, and gravity then causes the severed sheets to fall into two stacks 72 and 74 of severed pieces of sheet metal therebelow on top of a conventional pallet 80, which sits on top of a conventional vertically movable stacker platform 90. Typically, pallet 80 is made of metal, but also can be made of wood or plastic or any combination of these three materials. As best shown in FIG. 2, a conventional pallet 80 may have a number of suitable horizontally-arranged passages or openings 82A, 82B, 82C, 82D etc. through its side walls 82, and openings 83A and 83B through its front and rear walls 83 through which bands of steel strap may be passed to tighten down the stacks of severed steel pieces onto the pallet for shipment, after the pallet is fully loaded, and has been removed from the unloading mechanism 100. As best shown in FIG. 3, a conventional pallet may have cut-out areas 84A through 84H in its top surface 84, which like passages 82A through 82C or 82D, help reduce the weight of the pallet.

Stacker platform 90 has a large rectangular bed 91 and includes a conventional height adjustment mechanism, schematically represented by scissors jack 92 with its two arms 94 and 96 connected by a pivot pin 98. Typically, the level of the stacker platform is dropped automatically via a conventional spring balanced or motorized mechanism (not shown) as more weight from the growing steel stacks on the pallet is added to the platform during the running of the blanking machine. In this well-known manner, stacks of severed sheet metal taller than the sides of the unloader mechanism may be formed.

FIGS. 2 and 3 illustrate a conventional web drive and longitudinal slitter or cutter mechanism 42. Mechanism 42 has a suitable drive framework that includes motorized gear-reducer transmission boxes 44 for rotatably powering, in conventional fashion, drive axles 45 and 46 to which are respectively connected to the conventional drive rollers 47 and cutter rollers 48. Superstructure support bars 49 are used to provide a framework to support conventional ball bearings or other journals (not shown to avoid drawing clutter) for the drive axles 45 and 46 at suitable intervals. The cutter rollers 48, which are also referred to as slitters, just like the rest of drive roller and cutter mechanism 42, are well known and form no part of the present invention.

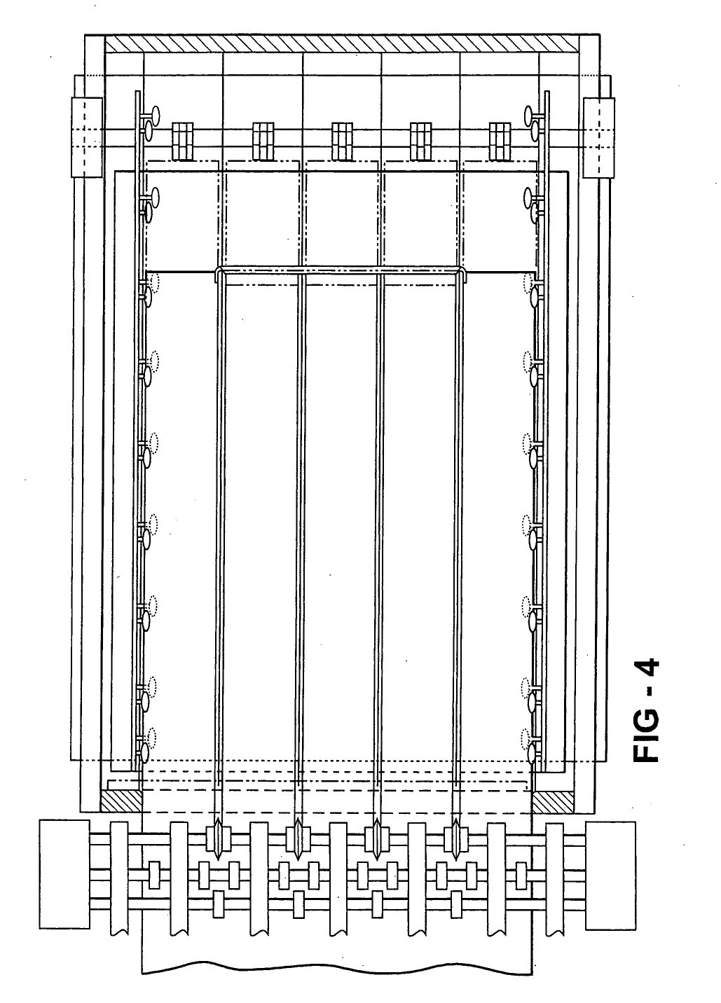

As best shown in FIG. 2, an initial strip 32, which is longitudinally severed but not yet transversely severed, advances while supported by a slidable top guide mechanism 200 of the present invention. The top guide 200 will be described later in connection with FIGS. 4 through 8. When the strip 32 has advanced sufficiently, as shown by the distal tip 32E of phantom strip 32A, it is severed at the opposite or proximal end by downwardly advancing blade 58. This causes the severed strip to drop downwardly as indicated by arrow 33 and by severed phantom strip 32D, so that it is added to a growing stack of fully severed strips forming on top of pallet 80. As will be explained later, only the initial strip 32 need be supported by movable guide 200 of the present invention. After the first strip 32F is in place on top of the pallet 80, the subsequent advancing strips may droop down, with the distal end thereof contacting and sliding along the fully severed strip already on the pallet. When fully advanced, blade 58 will again cycle , thus severing and dropping the proximal end 32G of a fully cut strip onto the growing stack of fully severed strips.

Referring now to FIGS. 1 through 3, the overall structure of the conventional unloading and stacking mechanism 100 will now be described. Mechanism 100 includes an upper generally rectangular framework 110 supported by a plurality of vertical leg members 102. The upper frame 110 includes left and right longitudinal frame members 112 and 114 and front and back transverse frame members 116 and 118. Although not shown in FIG. 1, a vertically slotted transversely positionable support structure is normally provided generally beneath the transverse frame members into order to the vertical dividers which are best seen in adjustable supports for Normally Mechanism 100 also includes a longitudinally movable backstop support mechanism 120, which may be provided with a motorized control (not shown), which includes a horizontally arranged transversely-oriented backstop support bar 121 which is carried by vertical brace members 122 and 124. The motorized control mechanism allows the support mechanism 120 to be incrementally moved forwardly or rearwardly as needed in order to position the backstops 320 at any desired longitudinal location relative to the advancing severed strips 32 and 34. In this manner, the backstops can be used to ensure that the rapidly advancing steel, when severed does not travel forward in the direction of arrow 45 more than desired, so that the severed sheet will drop into a generally neat stack below on top of the pallet 80.

FIG. 1 also shows that the unloader and stacking mechanism 100 includes side-restraint or side guide system 130 to help ensure that the severed sheets fall neatly onto the growing stack below on the pallet 80, by guiding and constraining the permissible location of the left and right outer edges of the severed sheets on the growing stack. Guide system 130 includes left and right longitudinally arranged side guide assemblies 132 and 134 and transversely arranged horizontal support rods 136 and 138, on which assemblies 132 and 134 are slidably adjustable inwardly and outwardly. Side guide assemblies 132 and 134 respectively include elongated longitudinally arranged generally flat support plates 142 and 144 and longitudinally arranged generally flat side guides 146 and 148 hinged to hanging downwardly therefrom. Support plate 142 carries left side guide 146, and support plate 144 carries right side guide 148. The outer left and right edges of the falling severed pieces of cut sheet slidably contact and are locationally constrained respectively by the inwardly facing wall-like surfaces of elongated side guides 146 and 148. Guides 146 and 148 are hinged in known manner so that a slight outward movement is possible, which substantially eliminates the possibility of part bind-up, i.e., a severed piece becoming stuck when dropping slightly out of kilter from a normal drop.

Thus, as can be seen when considering FIGS. 1 and 2 as a whole, all four sides of a fully severed falling sheet are constrained by the forwardly facing rear wall 57 of the die plate 56, the front surfaces 207 of the adjustable backstops 200, and the inwardly facing walls or faces of the side guide 146 and 148. In general, for large pieces of severed sheets of flat metal stock, particularly those which overhang the pallet in the front and back, as shown in FIG. 2, conventional backstops, side guides and the rear wall of the lower die plate 56 to a good job of providing a neat stack of the severed pieces of flat metal sheet on the pallet 80, particularly after the first few pieces have been deposited upon the pallet. The devices and assemblies of the present invention, which will shortly be described in order are all directed at helping handle the difficult initial severed strips of thin steel and the smaller-sized severed pieces that are often cut on automatic blanking machines, and are difficult to stack neatly, which results in the problems are previously noted in the background above.

FIG. 3 shows that the mechanism 100 also includes divider plates, which are very thin sheets of sturdy steel.

Epilogue. The foregoing detailed description shows that the preferred embodiments of the present invention are well suited to fulfill the objectives above-stated. It is recognized that those skilled in the art may make various modifications or additions to the preferred embodiments chosen to illustrate the present invention without departing from the spirit and proper scope of the invention. For example, the length and width of the fixed top guides and side guides may be varied. Also, different arrangements for supporting the removable light-weight backstops may be utilized. Accordingly, it is to be understood that the protection sought and to be afforded hereby should be deemed to extend to the subject matter defined by the appended claims, including all fair equivalents thereof.

1. A movable top guide, for use in an unloading and stacking mechanism of an automatic precision blanking machine having at least first and second elongated dividers spaced apart from and arranged parallel to one another, the top guide being for receiving and supporting distal end portions of one or more relatively flat thin flexible sheets of metal being advanced out of and to be severed by the precision blanking machine, the top guide comprising:
an elongated substantially rigid support structure longitudinally movable with respect to the first and second dividers and of sufficient length to span transversely across and be slidably supported by the upper edge portions of the first and second dividers,
the support structure including at least a first front elongated wall portion, a first central elongated portion, and a first rear elongated wall portion,
the front wall portion being arranged to support at least one underside surface of a first thin flexible elongated strip of sheet metal near the distal end thereof as the strip of sheet metal is being advanced out of and being severed by the precision blanking machine into a cut-to-length piece,
the rear wall portion being arranged to be contacted by the distal edge of the thin flexible elongated strip of sheet metal being advanced out of the precision blanking machine, such that the support structure is advanced along the dividers by the advancing distal edge of the strip of sheet metal,
whereby the distal end of the first strip of sheet metal being advanced out of the precision blanking machine is supported for a substantial distance along the dividers until the first strip is severed into a cut-to-length piece and drops between the dividers.

2. The movable top guide of claim 1, wherein:
the substantially rigid support structure includes at least first and second elongated formed members adjustable with respect to one another and partially nestable within one another in order to extend across and be slidably supported by the upper edge portions of the first and second elongated dividers when those first and second dividers are set at different spacings to accommodate cut-to-length pieces of sheet metal having different widths that are to be stacked,
the first and second formed members each including a front elongated wall portion, central elongated portion, and a rear elongated wall portion, and a spaced side wall portion extending from at least one of the elongated portions and arranged to overhang one of the dividers,
at least one of the elongated front wall portions being arranged to support at least the underside surfaces of the thin flexible sheets of metal near the distal ends thereof as the thin flexible sheets of metal are being advanced out of and to be severed by the precision blanking machine,
at least one of the elongated rear wall portions being arranged to be contacted by the distal ends of the thin flexible sheets of metal being advanced out of and to be severed by the precision blanking machine, whereby the movable guide assembly advanced along the dividers by the advancing distal ends of the sheet metal,
whereby the distal end of at least first piece of sheet metal being advanced out of the precision blanking machine may be supported for a substantial distance along the dividers until the first piece is severed and drops between the two of the dividers.

3. The movable top guide of claim 2, wherein:
the first and second members are each formed at least primarily from sheet metal;
the front, central and rear wall portions of the first and second members each have at least one substantial planar segment thereof; and
the substantially planar segments of the front and rear wall portions of the first formed member are each bent at acute angle with respect of the substantially planar segment of the central wall portion of the first formed member; and
the substantially planar segments of the front and rear wall portions of the second formed member are each bent at acute angle with respect of the substantially planar segment of the central wall portion of the second formed member.

4. The movable top guide of claim 3, wherein:
the first formed member nests partially within the second member;
the first formed member is telescopically adjustable with respect to the second formed member, and
the first and second members are each lightweight, and are hand-adjustable with respect to one another, and
the guide assembly is readily carried by hand. and first and second side wall portions extending downwardly from opposite at least one of the elongated portions and arranged to overhang the dividers.

5. The movable top guide of claim 4, wherein:
the first formed member includes at least a first spaced side wall portion that extends from the central elongated portion of the first formed member and that is arranged to overhang a first one of the dividers, and
the second formed member includes at least a first spaced side wall portion that extends from the central elongated portion of the second formed member and that is arranged to overhang a second one of the dividers spaced from the first one of the dividers.

6. A hand-removable lightweight side guide assembly, for use in an unloading and stacking mechanism of an automatic precision blanking machine having at least first and second elongated dividers spaced apart from and arranged parallel to one another, the guide assembly being for restraining a particular side edge of relatively short, flat and thin pieces of severed sheet metal successively being advanced out of the precision blanking machine from a roll of sheet metal, the guide assembly comprising:
a first elongated formed member having a substantially flat large surface portion and a first substantially flat small surface portion arranged at an obtuse angle with respect to the large surface portion;
a second elongated formed member having a substantially flat large surface portion and a first small surface portion generally arranged at an obtuse angle with respect to the large surface portion, and also having a second small surface portion arranged at an acute angle relative to the first small surface portion so as to form a hanger structure, whereby the second elongated formed member is arranged to be hung from one of the dividers of the unloading and stacking mechanism; and wherein
the first and second elongated members are arranged so that the large surface of the first elongated formed member is positionable to be contacted by the side edges of the flat thin sheets of sheet metal to be restrained as gravity causes them to drop,
whereby the thin sheets of sheet metal drop into a stack of severed pieces of sheet metal where the restrained edges of pieces of sheet metal are neatly arranged in a common generally vertical plane.

7. The side guide assembly of claim 6, wherein the first and second elongated members are rigidly connected together such that the large substantially flat surfaces of the first and second formed members are maintained in substantially parallel relation and are spaced apart from one another.

8. The side guide assembly of claim 7, further comprising a third elongated formed member rigidly connected to and spacing the first and second elongated members from one another in the substantially parallel relation, the third formed member being connected to the substantially flat large surfaces of the first and second members.

9. The side guide assembly of claim 8 wherein the second and third members are shorter in length than the first member and are centrally located with respect to the large flat surface of the first member.

10. The side guide assembly of claim 9 wherein the small surfaces of the first and second formed members:
have substantially different lengths, have about the same width, and each have a distal edge arranged along a common plane to substantially perpendicular to the large flat surfaces of the first and second formed members.

11. A lightweight hand-removable backstop, for use in an unloading and stacking mechanism of an automatic precision blanking machine having at least one backstop support, the backstop structure being for helping restrain distal edges of cut-to-length pieces of sheet metal that are shorter than a pallet upon which such pieces are stacked as they are severed and ejected from the blanking machine into the unloading and stacking mechanism, in order to ensure very neat stacking of the severed lengths of cut metal successively being advanced out of and severed by the precision blanking machine from a roll of sheet metal, the hand-removable backstop structure comprising:
an elongated substantially rigid structure arranged to be removably installed upon and rigidly supported in position by the backstop support of the unloading and stacking mechanism, the rigid structure having first, second and third elongated sections, with first and third sections being generally vertically arranged when the backstop is in use, and second section being generally horizontally arranged when the backstop is in use,
the first section being configured to be hand-mounted upon and mechanically supported by the backstop support;
the second section being disposed between and operatively rigidly interconnecting the first and third sections,
the third section having at least one substantially flat large surface portion arranged to have a generally vertical orientation when the backstop is in use,
the backstop, when in use, being of sufficient length in a horizontal direction such that all of the third section and at least a portion of the second section extend over at least part of a pallet positioned therebelow upon which ejected pieces of cut-to-length sheet metal are stacked as they are severed by the blanking machine and dropped into the unloading and stacking mechanism,
the large flat surface portion of the third section being configured to be generally perpendicular to the direction of the advancing strips of sheet metal prior to being severed, and
the backstop being arranged to be positioned when in use to restrain the distal edges of the severed cut-to-length pieces of sheet metal as gravity causes them to drop,
whereby the pieces of sheet of sheet metal drop into a stack upon the pallet with their restrained distal edges neatly arranged in a common generally vertical plane.

12. The hand-removable backstop of claim 11, wherein:
the third section has a first substantially flat small surface portion arranged, when the hand-removable backstop is n use, generally above and at an obtuse angle with respect to the large surface portion,
the second section has a bottom surface arranged, when the hand-removable backstop is in use, to rest upon the portions of the top surface of a pallet upon which severed cut-to-length pieces of sheet metal are to be stacked, and
a lower segment of the large surface portion of the third section extends beneath the bottom surface of the second section, whereby the lower segment may be positioned, when the hand-removable backstop is in use, below the top surface of the pallet by being positioned to fall within an opening provided in the top surface of the pallet, thereby ensuring that a generally vertical wall all the way to the top surface of the pallet is provided, so that even the initial cut-to-length pieces of sheet metal upon the stack are properly registered along the generally vertical wall formed by the large surface portion of the third section.

13. The hand-removable backstop of claim 11, wherein:
the elongated substantially rigid structure is formed from first, second and third structural members which are initially made separately and subsequently joined together, and which correspond respectively to the first, second and third sections of the substantially rigid structure, and
the second structural member includes at least a first elongated wall portion having a length at least twice its width, the first elongated wall portion being rigidly attached to at least one of the first and third formed members.

14. The hand-removable backstop of claim 11, in which backstop support of the unloading and stacking mechanism has two substantially rigid vertically projecting support members each of the generally rectangular horizontal cross-section along most of their length, and spaced apart from one another by a first transverse horizontal distance, and wherein:
the first structural member has along at least most of its length an H-shaped horizontal cross-section, and the crossbar portion of the H-shaped crossbar section whereby the first section may be positioned about a backstop support having two substantially rigid vertically projecting support members spaced apart from one another by a horizontal distance slightly greater than the crossbar portion of the H-shaped cross-section, and

15. The hand-removable backstop of claim 11, wherein the second section is formed from first and second telescoping members and releasable mechanical restraint means for rigidly interconnecting the first and second telescoping members together,
the first telescoping members being rigidly interconnected to the first section of the backstop, and the second telescoping member being rigidly interconnected to the third section of the backstop,
the releasable mechanical restraint means being arranged to provide adjustable set up of the second section between at least three different positions that each provide a different overall length for the second section, by releasing the mechanical restraint means, making a desired length adjustment, and re-engaging the mechanical restraint means,
whereby the backstop may be adjusted by an operator during set up to any one of at least three different overall lengths.

16. The hand removable backstop of claim 15 wherein:
first and second telescoping members each are substantially hollow, each have at first and second opposed elongated wall portions and each have a substantially uniform cross-section along at least most of their length, the uniform cross-sections of the first and second telescoping members being slightly different and size and complementary to one another to allow the first and second telescoping members to be slidably positioned with respect to one another when the mechanical restraint means is released;
the first telescoping member has at least three pairs of through-holes in the first and second opposed wall portions thereof, each pair of holes being arranged directly opposite one another, such that an elongated removable fastener may be placed through any pair of the holes;
the second telescoping member has at least three pairs of through-holes in the first and second opposed wall portions thereof, each pair of holes being arranged directly opposite one another, such that an elongated removable fastener may be placed through any pair of the holes; and
the releasable mechanical restraint means includes at least one removable elongated fastener which is operable, during set up of the overall length of the backstop, to be placed through a first selected pair of opposed holes in the first telescoping member and a second selected pair of opposed holes in the second telescoping member that are in substantial registration with the first selected set of opposed holes, whereby the overall length of the backstop is determined by which pairs of opposed holes in the first and second telescoping members are selected.

17. The hand removable backstop of claim 11 wherein:
the substantially rigid elongated structure is made primarily from lightweight metal alloys, and
the third section includes a generally flat permanent wall portion to which the substantially flat large surface portion is attached, and
the large surface portion may be made from made from a harder material that is more resistant to wear than generally flat permanent wall portion.

18. In an unloading and stacking mechanism of an automatic precision blanking machine, having at least one laterally arranged backstop support bar, and improved backstop assembly comprising:
a first vertical member,
two horizontal connection bar members,
two generally vertically arranged projecting contact members,
the two horizontal connection bar members each having an upper and lower surfaces arranged generally parallel to one another and each extending outwardly from the first vertical member, the two bar members being spaced apart from one another in parallel relation and rigidly supporting two vertically projecting contact members,
each of the contact members being of a generally rectangular horizontal cross-section along most of their vertical length, and being spaced apart from one another and each having face surface contacted, during use of the backstop assembly, by the distal edge of cut-to-length pieces of sheet metal, the face surfaces of the first and second contact members each being generally flat along most of their length and arranged in the same generally vertical plane,
the contact members being characterized by:
the flat portion of each face member extending substantially below a horizontal plane defined by the lower surfaces of the two horizontal connection bar members, whereby the initial few severed pieces of cut-to-length pieces of sheet metal to drop to a pallet to begin forming a stack of such severed pieces do not end up sliding partially under the first and second contact members, which helps ensure that all severed cut-to-length pieces of sheet metal stack neatly with their distal edges all arranged along a common vertical plane.

19. The improved backstop assembly of claim 18, wherein:
wherein the lowest portion of each face member extends at least one-half inch below the lowest portion of the flat portion of face member extending substantially below a horizontal plane, on account of the lowest portion being recessed, whereby the improved backstop assembly weighs less than if the flat portion of the face members had extended substantially all the way along the lowest portion of each face member.

20. The improved backstop assembly of claim 18, wherein:
the faces of the generally vertically arranged projecting contact members each include an upper portion having a slanted surface that extends upwardly and away from the vertically flat part of the face portion, the slanted surface being sufficiently steeply sloped to assist in a distal edge of a severed cut-to-length piece of sheet metal fall downwardly toward an area where a neat stack of cut-to-length pieces is supposed to form.
